(19) United States
(12) Patent Application Publication
(10) Pub. No.: US 2009/0177970 A1
(43) Pub. Date: Jul. 9, 2009

(54) Method for online servicing of a field device of automation technology

(75) Inventors: Gunter Jahl, Lochgau (DE); Holger Eberhard, Backnang (DE); Immanuel Vetter, Sinzheim (DE); Alexander Terentiev, Mannheim (DE); Omar Montalvo, Karlsruhe (DE)

Correspondence Address: BACON & THOMAS, PLLC, 625 SLATERS LANE, FOURTH FLOOR, ALEXANDRIA, VA, 22314-1176, US

(73) Assignee: CodeWrights GmbH, Karlsruhe (DE)

(21) Appl. No.: 12/003,250

(22) Filed: Dec. 21, 2007

(30) Foreign Application Priority Data
Dec. 29, 2006 (DE) 10 2006 062 605.2

(51) Int. Cl. G06F 15/177; G06F 3/048

(52) U.S. Cl. 715/735

(57) ABSTRACT

A method for online servicing of a field device of automation technology with a servicing program running on a computer unit connected with the field device via a communication connection. The servicing program requires a device description for display of field-device-specific servicing elements or menu structures, and it is provided that the field device is opened via the device description and field-device-specific servicing elements or menu structures for transmitting from the field device to the device description, so that the field-device-specific servicing elements or menu structures can be displayed with the help of the servicing program.

### TECHNICAL FIELD

The invention relates to a method for online servicing of a field device of automation technology, with a servicing program running on a computer unit connected with the field device via a communications connection.

### BACKGROUND DISCUSSION

Field devices are commonly employed in automation technology (process automation/manufacturing automation) and serve for registering and/or influencing process variables. Examples of such field devices are fill level measuring devices, mass flow measuring devices, pressure- and temperature-measuring devices, pH- and redox-potential-measuring devices, conductivity measuring devices, etc. for process automation technology, which, as sensors, register the corresponding process variables, fill level, flow, e.g. flow rate, pressure, temperature, pH-value and conductivity value, respectively.

Serving for influencing process variables are actuators, e.g. valves, which control flow of a liquid in a section of pipeline, or pumps, which change fill level in a container.

A large number of such field devices are manufactured and sold by the firm, ENDRESS+HAUSER®.

Frequently, field devices are connected with superordinated units via communication systems (PROFIBUS®, FOUNDATION-FIELDBUS®, HART®, etc.). Such superordinated units serve for process control, process visualization, device-management (configuration and servicing) and for plant management (asset management), using corresponding application programs.

The integration of field devices into such applications occurs via device descriptions. Device descriptions are provided by device manufacturers, in order that superordinated units can recognize and interpret the meaning of data supplied by the field devices.

Various device descriptions are known for the different fieldbus systems (HART-device-descriptions, Fieldbus Foundation device descriptions, Profibus device descriptions).

On the basis of cooperation of Fieldbus Foundation (FF), HART Communication Foundation (HCF) and Profibus Nutzerorganisation (PNO), an electronic device description (Electronic Device Description EDD) was created, which is defined in the standard IEC 61804-2.

With a large number of EDD-based fieldbus systems installed worldwide, EDD is a very widely used description language for device descriptions in automation technology.

For servicing field devices, corresponding servicing programs (operating tools) are necessary, which, in superordinated units, run either on their own (Endress+Hauser FieldCare, Pactware, AMS Fisher-Rosemount, PDM Siemens) or else are integrated into control system applications (Siemens PCS7, ABB Symphony, Emerson Delta V).

For a comprehensive servicing of field devices, newly, special device descriptions, so-called DTMs (Device Type Manager), are available, which correspond to the FDT (Field Device Tool) specifications. The FDT-specifications, serving as an industry standard, were developed by the PNO (Profibus Nutzer Organisation (Profibus User Organization)) in cooperation with ZVEI (Zentralverband Elektrotechnik-und Elektroindustrie (The German Electrical and Electronics Industry, a registered association)). The current FDT-Specification 1.2.1, including the Addendum for “Foundation Fieldbus” Communication, is available from ZVEI, PNO or the FDT-Group.

Many field device manufacturers already deliver corresponding DTMs for their field devices. The DTMs encapsulate all variables and functions of the pertinent field device and offer, most often, a graphical user interface for servicing the devices.

As run-time environment, the DTMs require a frame application (FDT-frame). The frame application and the corresponding DTMs permit, thus, a very comfortable access to field devices (e.g. to device parameters, measured values, diagnostic information, status information, etc.), as well as serving for invoking special functions, which individual DTMs make available.

Frame applications and DTMs form together a component-based management system for field devices.

Modern field devices have a large number of adjustable parameters. In the case of complex field devices, the parameter count can become extremely large due to their large number of options.

To cover this multiplicity of parameters (sometimes more than 5000) with a single device description is extremely difficult and time-consuming.

Device descriptions must, as a rule, pass a complex certification process, before they can be used. Therefore, especially for reasons of cost, it is not possible to take into consideration customer-specific parameters in device descriptions.

Changes in the firmware in field devices, when the changes concern parameters, require, as a rule, a modification of the device description. For the user, a frequent updating of device descriptions is very disturbing.

Normally, device descriptions can only be produced, after the firmware and, especially, the contents of the device servicing are known.

### SUMMARY OF THE INVENTION

An object of the invention is, therefore, to provide a method for online servicing of a field device of automation technology, which method does not exhibit the above mentioned disadvantages.

This object is achieved by opening the field device via the device description and field-device-specific operating elements or menu structures for transmitting from the field device to the device description, in order to display the field-device-specific operating elements or menu structures with the help of the servicing program.

An essential idea of the invention is that the field device itself delivers servicing elements, respectively menu structure, required by the servicing program.

### BRIEF DESCRIPTION OF THE DRAWING

The invention will now be explained in greater detail on the basis of an example of an embodiment presented in the drawing, the figures of which show as follows:

FIG. 1 is a basic structure of a component-based management system for field devices of automation technology.

### DETAILED DESCRIPTION

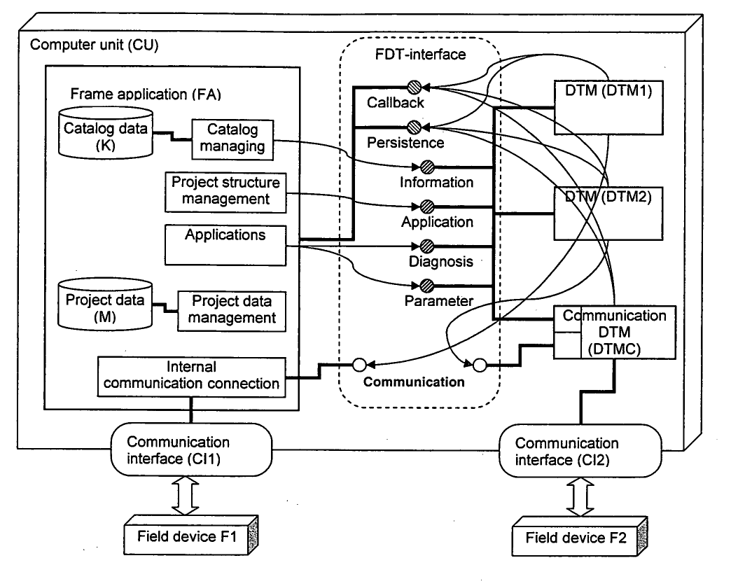

FIG. 1 shows, schematically, the basic structure of a component-based management system for field devices of automation technology. The management system is based on the FDT concept. A frame application FA, which runs on a computer unit CU, communicates via defined FDT-interfaces FDT with device manager instances DTM1, DTM2, which enable a comprehensive servicing of the field device types associated with the respective device managers. The frame application FA also communicates with the communication manager instance DTMC, which enables a comprehensive servicing of the interface. The frame application FA can be, for example, the product FIELDCARE® of the firm, Endress+Hauser. Frame application FA serves for, among other things, managing and instantiating various objects; in such case, the frame application is responsible for building the project structure, establishing connections between device- and communication-manager-instances, starting and managing applications, storing and loading project data, as well as production and destruction of projects.

For managing project structure, each device manager and communication manager offers information via its Information interface. On the basis of this information, the frame application FA can accumulate catalog data K needed for managing project structure. With the project structure, the frame application controls and manages also the communication paths. FIG. 1 shows two communication networks (e.g. fieldbuses), which are accessed via communication interfaces CI1, CI2. The device manager instances do not communicate with the field devices directly, but, instead, utilize the communication interface of FDT, which can be offered both by the frame application FA and also by a communication-manager instance. In FIG. 1, the device manager instance DTM1 communicates via a communication interface CI1 in the frame application FA with the field device F1 associated therewith, while the device manager instance DTM2 communicates with the field device F2 with the help of the communication-manager instance DTMC via a communication interface CI2. Frame application FA manages applications, which are part of the frame application, as well as also managing device manager- and communication manager-specific applications. Internal applications of the frame application FA, such as diagnostic methods and data registering, use the FDT interfaces for exchanging data with the device- and communication-manager-instances. Device manager- and communication manager-specific applications are managed by the frame application by means of an Application interface. The frame application queries, for this purpose, via an Information interface, type and number of the available applications.

The persistence of the project data is implemented by the frame application FA with the help of a Persistence interface, which are served by the device- and communication-manager instances.

Frame application FA forms, together with the device manager instances DTM1, DTM2 and the communication manager instance DTMC, etc., an object-based configuration system CS for field devices of automation technology.

As already mentioned, field device manufacturers make device managers available for their individual field devices. Before a field device can be accessed, the corresponding device manager, with all belonging objects, must be instantiated. The device managers comprise main objects and sub-objects

The method of the invention will now be explained in greater detail. For servicing and configuring a field device, e.g. field device F2, the user invokes the frame application FA, as servicing program, and DTM2, as device description for the field device F2. For the offline the servicing of the field device F2, DTM2 makes available a simple servicing menu, via which, however, not all parameters of the field device F2 can be serviced. For the online servicing, a communication connection to the field device F2 via the communication interface CI2 is necessary.

Via DTM2, field device F2 is opened. Then, the field device transmits field-device-specific servicing elements, respectively menu structures, which can be displayed in the frame application FA with the help of the DTM, DTM2. The field-device-specific menu structures are, as a rule, present in the field device F2, since field devices most often possess an on-site servicing capability.

Only when the user would like to access parameters, which are not provided by the offline servicing, are the corresponding servicing elements, respectively menu structures, retrieved from the field device F2.

In a further development of the invention, via the device description, methods are invoked, via which actions are triggered in the field device.

The operating elements can be e.g. selection menus, parameters or units.

In principle, the computer unit CU serves near-time as terminal for display of information stored in the field device F2.

The device description, the DTM, does not know which operating elements, respectively which menu structure, needs to be displayed. Rather, the device description queries the field device F2 as to what is available for display.

The method of the invention is suitable not only for DTMs as device descriptions, but, instead, in principle for any device descriptions, e.g. HART, Profibus, Foundation fieldbus, EDDs, etc.

The method of the invention offers the following advantages relative to conventional device descriptions. The firmware in the devices can be expanded by addition of parameters, without it being necessary that the device description for the device be changed, since corresponding parameters, servicing elements, menu structures are read out of the field device and do not originate in the device description. As a result, there is no need for updates of the device descriptions in the computer units (control systems, control units, etc.). Furthermore customer-specific parameters can be implemented at low cost. Likewise, customer-specific parameters can be provided quicker by the device manufacturer.

The upload and download times can be significantly decreased, since parameters which are only needed for online servicing (e.g. version information) or which are only needed infrequently, need only to be accessible via the method of the invention.

With the method of the invention, it is not necessary to know the exact contents of the device servicing already at the time of the design of the device descriptions, since contents can be activated first at runtime.

A significant advantage, which the method of the invention offers, is that, in the case of changes of the firmware, no new device descriptions need to be produced, for which complex certification processes are required.

Furthermore, an intuitive servicing of the device is possible, since graphical servicing elements can be built at runtime, based on information retrieved from the field device.

1-4. (canceled)

5. A method for online servicing of a field device of automation technology with a servicing program running on a computer unit connected with the field device via a communication connection comprising the steps of:
providing a device description for display of field-device-specific servicing elements or menu structures; and
opening the field device via the device description and field-device-specific operating elements or menu structures for transmitting from the field device to the device description, in order to display the field-device-specific operating elements or menu structures with the help of the servicing program.

6. The method as claimed in claim 5, wherein:
the device description invokes methods, via which actions are triggered in the field device.

7. The method as claimed in claim 1, wherein:
the servicing elements are selection menus.

8. The method as claimed in claim 1, wherein:
the servicing elements are parameters or units for measured values.
